(19) United States
(12) Patent Application Publication
(10) Pub. No.: US 2016/0142624 A1
(43) Pub. Date: May 19, 2016

(54) VIDEO DEVICE, METHOD, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventor: Tatsuo Niigaki, Kumagaya Saitama (JP)

(21) Appl. No.: 14/677,573

(22) Filed: Apr. 2, 2015

(30) Foreign Application Priority Data
Nov. 19, 2014 (JP) 2014-234955

(51) Int. Cl. H04N 5/232

(52) U.S. Cl. CPC H04N 5/23219; H04N 5/23216; H04N 5/23293

(57) ABSTRACT

According to one embodiment, a video device is capable of displaying a video on a display region of a display provided with a touch panel. The video device includes: an acquisition module configured to acquire an image from a camera configured to image a region opposed to the display region; a detection processor configured to detect a position of a user's face opposed to the display region based on the acquired image; and a display processor configured to display, based on a detection result of the detection processor when a first operation image to operate the video device is displayed on the display region, a second operation image obtained by reducing in size the first operation image on a first region of apart of the display region, the first region corresponding to the position of the user's face.

### CROSS-REFERENCE TO RELATED APPLICATION(S)

This application is based upon and claims the benefit of priority from Japanese Patent Application No. 2014-234955, filed Nov. 19, 2014, the entire contents of which are incorporated herein by reference.

### FIELD

Embodiments described herein relate generally to a video device, a method, and a computer program product.

### BACKGROUND

Conventionally, there has been known a portable electronic device having a touch panel function to display an operation image for operating its own device.

In recent years, the touch panel function may have been included in a large video display device that is not portable in some cases. In this case, a burden on a user may increase in operating the touch panel of the video display device due to its large size.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a configuration of an external appearance of a video device according to an embodiment;

FIG. 2 is an exemplary block diagram illustrating a hardware configuration of the video device in the embodiment;

FIG. 3 is an exemplary block diagram illustrating a functional configuration of a computer program executed by a CPU of the video device in the embodiment;

FIG. 4 is an exemplary diagram illustrating an example of a positional relationship between a user and the video device in the embodiment;

FIG. 5 is an exemplary diagram illustrating a home screen displayed on a display horizontally arranged on the video device in the embodiment;

FIG. 6A is an exemplary diagram illustrating a reduced-size home screen displayed on a left region of the display horizontally arranged on the video device in the embodiment;

FIG. 6B is an exemplary diagram illustrating the reduced-size home screen displayed on a center region of the display horizontally arranged on the video device in the embodiment;

FIG. 6C is an exemplary diagram illustrating the reduced-size home screen displayed on a right region of the display horizontally arranged on the video device in the embodiment;

FIG. 7 is an exemplary diagram illustrating the home screen displayed on the display vertically arranged on the video device in the embodiment;

FIG. 8A is an exemplary diagram illustrating the reduced-size home screen displayed on a left region of the display vertically arranged on the video device in the embodiment;

FIG. 8B is an exemplary diagram illustrating the reduced-size home screen displayed on a center region of the display vertically arranged on the video device in the embodiment;

FIG. 8C is an exemplary diagram illustrating the reduced-size home screen displayed on a right region of the display vertically arranged on the video device in the embodiment;

FIG. 9 is an exemplary diagram illustrating a keyboard screen displayed on the display horizontally arranged on the video device in the embodiment;

FIG. 10 is an exemplary diagram illustrating the keyboard screen displayed on the display vertically arranged on the video device in the embodiment;

FIG. 11 is an exemplary diagram illustrating a menu bar displayed on the display of the video device in the embodiment;

FIG. 12 is an exemplary diagram illustrating an example in which the home screen of the video device is displayed on a portable terminal in the embodiment;

FIG. 13 is an exemplary block diagram illustrating a hardware configuration of the portable terminal in the embodiment;

FIG. 14 is an exemplary block diagram illustrating a functional configuration of a computer program executed by a CPU of the portable terminal in the embodiment;

FIG. 15 is an exemplary flowchart illustrating processing executed by the video device to display a reduced-size operation image, in the embodiment;

FIG. 16 is an exemplary flowchart illustrating processing executed by the video device to change a display position and a size of the reduced-size operation image, in the embodiment;

FIG. 17 is an exemplary flowchart illustrating processing executed by the video device to hide the reduced-size operation image, in the embodiment;

FIG. 18 is an exemplary flowchart illustrating processing executed by the video device to set a default display position and size of the reduced-size operation image, in the embodiment;

FIG. 19 is an exemplary flowchart illustrating processing executed by the portable terminal to display an image based on image data received from the video device, in the embodiment; and

FIG. 20 is an exemplary flowchart illustrating processing executed by the portable terminal to transmit operation information to the video device, in the embodiment.

### DETAILED DESCRIPTION

In general, according to one embodiment, a video device is capable of displaying a video on a display region of a display provided with a touch panel. The video device comprises: an acquisition module configured to acquire an image from a camera configured to image a region opposed to the display region; a detection processor configured to detect a position of a user's face opposed to the display region based on the acquired image; and a display processor configured to display, based on a detection result of the detection processor when a first operation image to operate the video device is displayed on the display region, a second operation image obtained by reducing in size the first operation image on a first region of a part of the display region, the first region corresponding to the position of the user's face.

The following describes an embodiment based on the drawings.

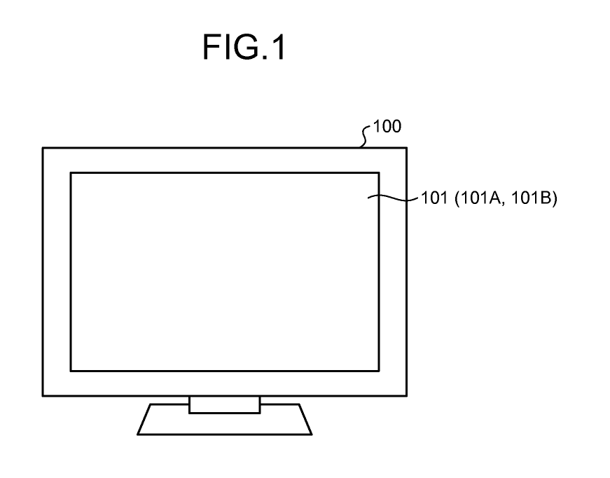

First, the following describes a configuration of an external appearance of a video device 100 according to the embodiment with reference to FIG. 1.

As illustrated in FIG. 1, the video device 100 comprises a display module 101 that can display a video such as a moving image and a static image. Examples of the video device 100 include a video display device such as a television and a monitor for a computer. The video device 100 described below is a large video display device.

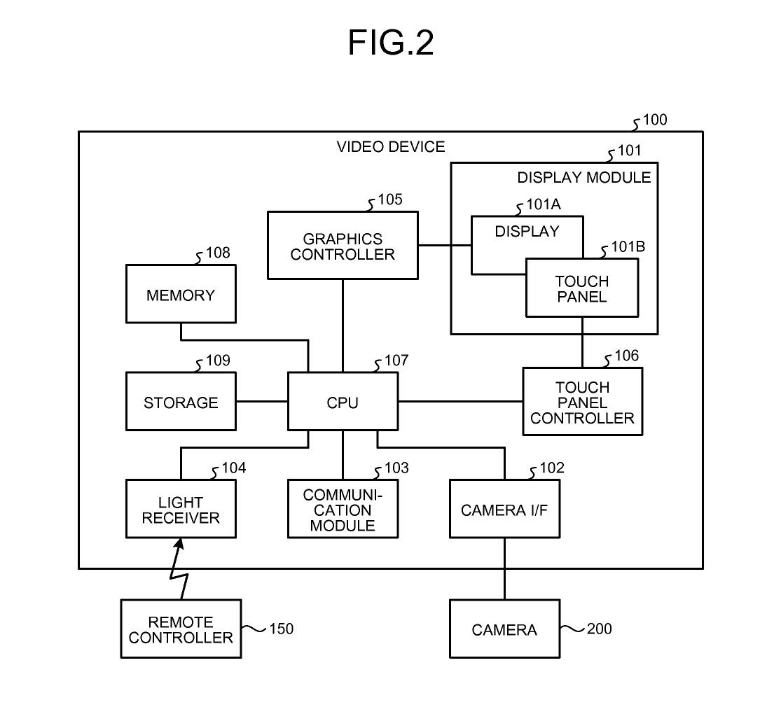

Next, the following describes a hardware configuration of the video device 100 in more detail with reference to FIG. 2.

As illustrated in FIG. 2, the video device 100 comprises a display module 101, a camera interface (I/F) 102, a communication module 103, a light receiver 104, a graphics controller 105, a touch panel controller 106, a central processing unit (CPU) 107, a memory 108, and a storage 109.

The display module 101 is what is called a touch screen device combining a display 101A and a touch panel 101B. Examples of the display 101A include a liquid crystal display device (LCD) and an organic electro luminescence (EL) display device. The touch panel 101B is configured to detect a position (touch position) in a display region of the display 101A touched by a user's finger, a stylus, and the like.

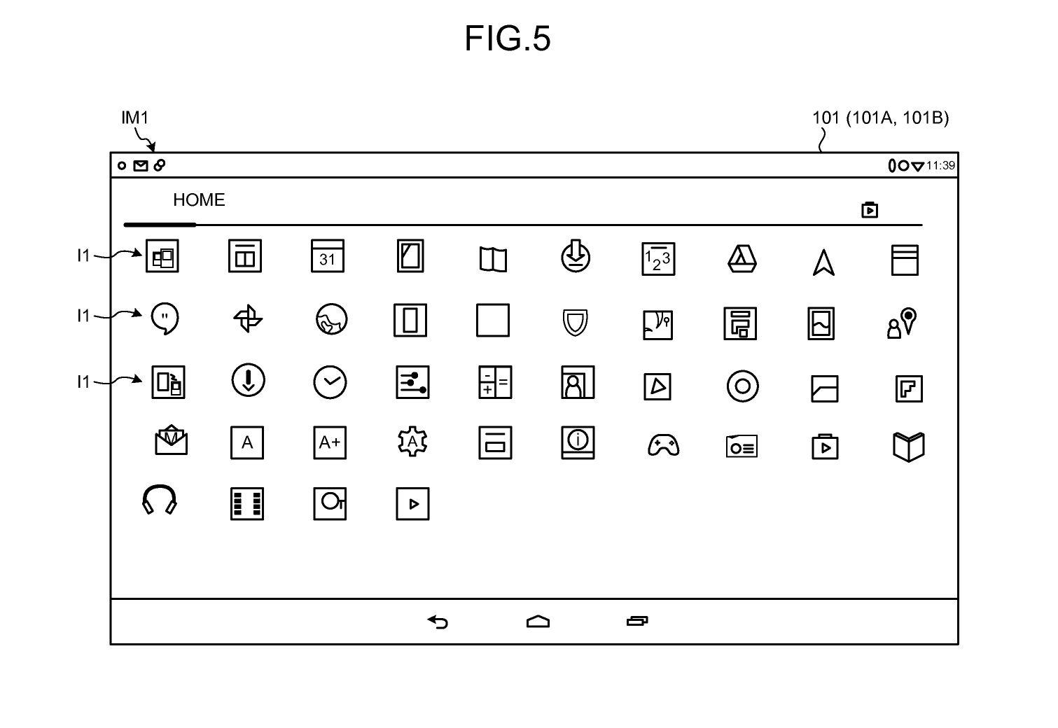

The camera I/F 102 is an interface connected to a camera 200. The camera 200 is an imaging device, such as a web camera, mounted on the video device 100. The camera 200 is configured to image a region opposed to the display region of the display 101A (refer to FIG. 4 described later). The communication module 103 is an interface for transmitting/receiving data to/from other devices (such as a portable terminal 400 described later). The light receiver 104 is configured to receive an infrared signal from a remote controller 150 for operating the video device 100.

The graphics controller 105 is configured to control a video output to the display 101A. The touch panel controller 106 is configured to control the touch panel 101B and to acquire coordinate data indicating the touch position in the display region touched by a user.

The CPU 107 is configured to control components of the video device 100 by executing various computer programs. The memory 108 comprises, for example, a read only memory (ROM) and a random access memory (RAM) serving as main storage devices, and is configured to store various pieces of data and various computer programs used for various processing executed by the CPU 107. The storage 109 comprises, for example, a hard disc drive (HDD) and a solid state drive (SSD) serving as auxiliary storage devices.

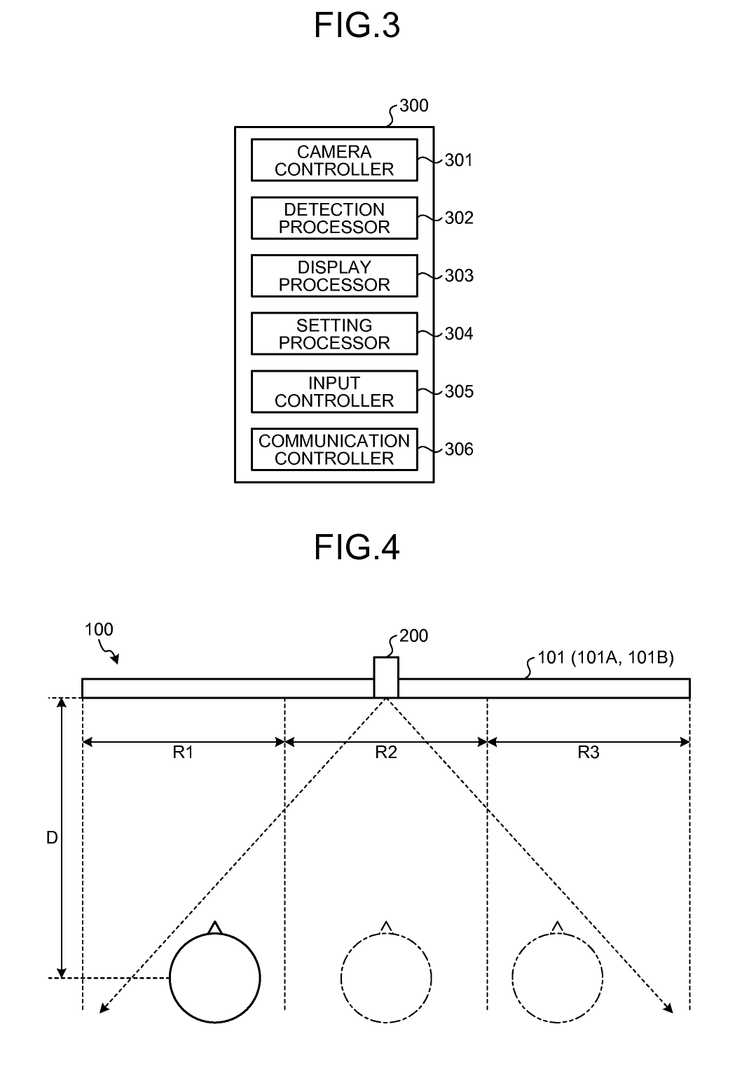

The CPU 107 is configured to execute a computer program 300 as illustrated in FIG. 3. The computer program 300 has a modular configuration as follows.

As illustrated FIG. 3, the computer program 300 comprises a camera controller 301, a detection processor 302, a display processor 303, a setting processor 304, an input controller 305, and a communication controller 306. Each of these modules is generated on the RAM of the memory 108 when the CPU 107 of the video device 100 reads and executes the computer program 300 from the ROM of the memory 108.

The camera controller 301 is configured to control the camera 200 connected to the camera I/F 102. For example, the camera controller 301 is configured to control a light source of the camera 200 and to acquire an image imaged by the camera 200 from the camera 200. The camera controller 301 is an example of an “acquisition module”.

The detection processor 302 is configured to detect a position of a user's face opposed to the display region of the display 101A based on the image imaged by the camera 200. More specifically, the detection processor 302 is configured to detect whether the imaged image comprises the user's face, and to detect the position of the user's face when the image imaged by the camera 200 comprises the user's face.

For example, as illustrated in FIG. 4, when the user's face is positioned at a position opposed to the display region of the display 101A, the image imaged by the camera 200 comprises the user's face. FIG. 4 schematically illustrates a user opposed to a left region R1 (refer to a solid line), a user opposed to a center region R2 (refer to a one-dot chain line), and a user opposed to a right region R3 (refer to a two-dot chain line) in a case where the display region is divided into the three regions R1 to R3. The detection processor 302 is configured to be able to detect a distance D (refer to FIG. 4) between the user and the display region based on a size of the user's face when the image imaged by the camera 200 comprises the user's face. The detection processor 302 is configured to detect the position of a user's face closest to the display region from among a plurality of users when the image imaged by the camera 200 comprises a plurality of faces of users.

Returning back to FIG. 3, the display processor 303 is configured to output a video to the display 101A. For example, the display processor 303 is configured to be able to display an operation image (a first operation image) for operating the video device 100 on the display 101A. The operation image is an image for receiving an input operation by the user via the touch panel 101B. The operation image is displayed in the whole display region of the display 101A.

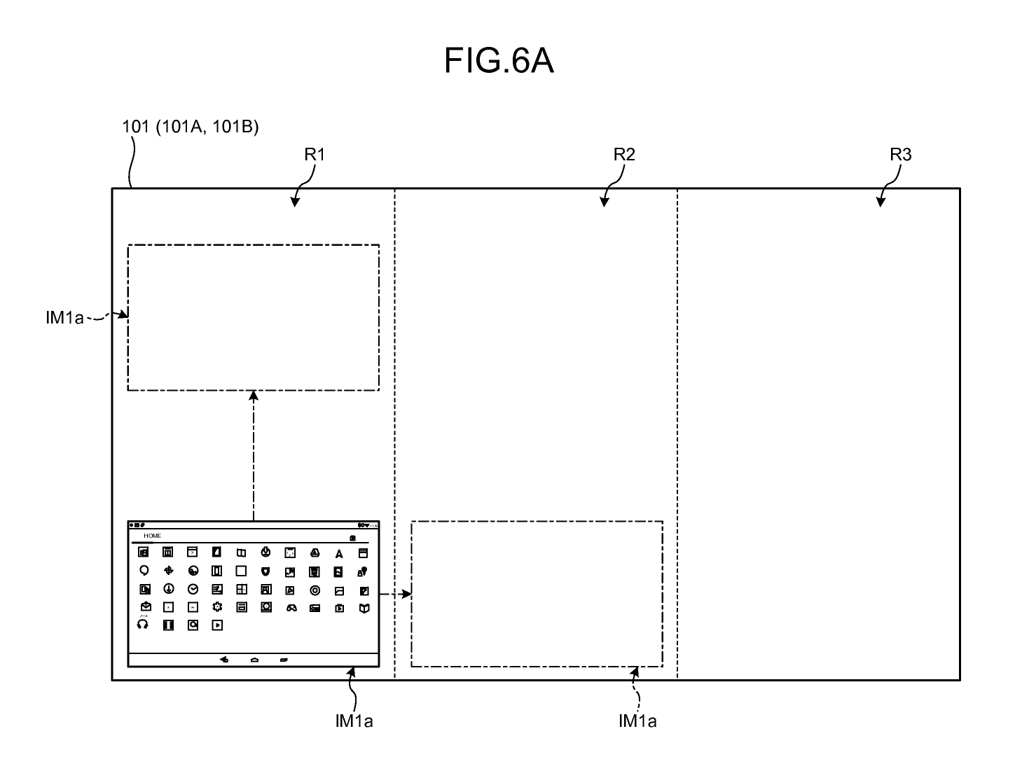

Examples of the operation image include a home screen, in the embodiment. The home screen is, for example, a basic screen as illustrated in FIG. 5 on which one or more icons are displayed for starting one or more applications installed in the video device 100. A plurality of icons I1 are displayed on a home screen IM1 in FIG. 5 for starting a plurality of applications installed in the video device 100.

The display processor 303 in the embodiment is configured to display a reduced-size operation image (a second operation image) on a first region based on a detection result of the detection processor 302 when the above-described operation image is displayed in the display region of the display 101A. The reduced-size operation image is obtained by reducing in size the above-described operation image. The first region is a region of a part of the display region and corresponds to the position of a user's face. The display processor 303 is configured to display the reduced-size operation image on the first region when it is confirmed that the distance between the user and the display 101A is equal to or smaller than a threshold.

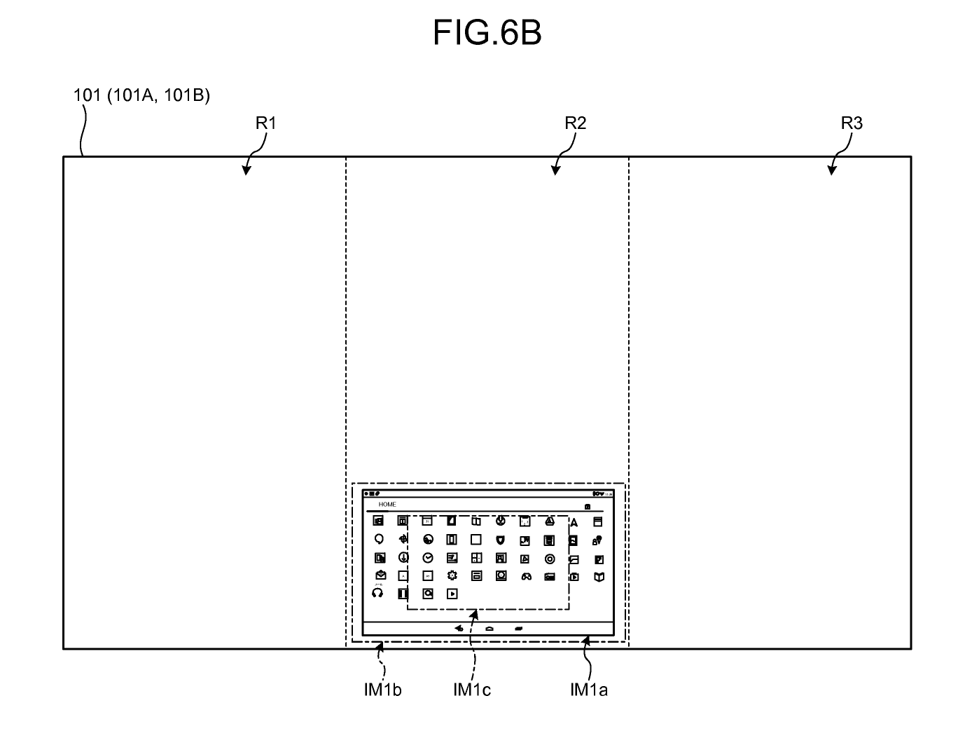

For example, when the user approaches the left region R1 of the display region in a state where the home screen IM1 of FIG. 5 is displayed on the display 101A, as illustrated in FIG. 6A, the display processor 303 is configured to display a reduced-size home screen IM1a obtained by reducing in size the home screen IM1 at a predetermined position in the region R1 in a predetermined size.

In addition, for example, when the user approaches the center region R2 of the display region in a state where the home screen IM1 of FIG. 5 is displayed on the display 101A, as illustrated in FIG. 6B, the display processor 303 is configured to display the reduced-size home screen IM1a obtained by reducing in size the home screen IM1 at a predetermined position in the region R2 in a predetermined size.

Furthermore, for example, when the user approaches the right region R3 of the display region in a state where the home screen IM1 of FIG. 5 is displayed on the display 101A, as illustrated in FIG. 6C, the display processor 303 is configured to display the reduced-size home screen IM1a obtained by reducing in size the home screen IM1 at a predetermined position in the region R3 in a predetermined size.

In the examples of FIG. 6A to FIG. 6C, the display region is divided into the three regions R1 to R3, and the reduced-size home screen IM1a is displayed in a region closest to the position of the user's face among the three regions R1 to R3. Alternatively, in the embodiment, the display region may be more finely divided into four or more regions, and the reduced-size home screen IM1a may be displayed in a region closest to the position of the user's face among the four or more regions. Dividing lines indicated by the dotted lines in FIG. 6A to FIG. 6C are not actually displayed in the embodiment.

In the examples of FIG. 6A to FIG. 6C, the reduced-size home screen IM1a is displayed at a lower position and a center portion in the horizontal direction of each of the regions R1 to R3. Alternatively, in the embodiment, the reduced-size home screen IM1a may be displayed near a position closest to the user's face in each of the regions R1 to R3 by use of the position of the user's face detected by the detection processor 302. In the embodiment, the user can set any position as a default display position of the reduced-size home screen IM1a. Similarly, in the embodiment, the user can set any size as a default size of the reduced-size home screen IM1a. The setting of the display position comprises not only the setting of the position in the horizontal direction (width direction of the video device 100) but also setting of the position in a vertical direction (height direction of the video device 100).

In the embodiment, the display position and the size of the reduced-size home screen IM1a can be changed after the reduced-size home screen IM1a is displayed. For example, the user can change the display position and the size of the reduced-size home screen IM1a by performing a swipe (drag) operation, a flick operation, or a pinch operation while touching a region of the touch panel 101B corresponding to the reduced-size home screen IM1a. That is, the user can move the reduced-size home screen IM1a in the horizontal direction and the vertical direction by performing the swipe operation or the flick operation (refer to a one-dot chain line in FIG. 6A). The user can enlarge the reduced-size home screen IM1a through a pinch-out operation (refer to the reference numeral IM1b in FIG. 6B), and can reduce the reduced-size home screen IM1a through a pinch-in operation (refer to the reference numeral IM1c in FIG. 6B). In this way, the display processor 303 in the embodiment is configured to change the display position and the size of the reduced-size home screen IM1a in response to an operation by the user via the touch panel 101B. The display position of the reduced-size home screen IM1a may be moved not only within each of the regions R1, R2, and R3, but also across the regions R1 to R3. For example, as illustrated in the example of FIG. 6C, the reduced-size home screen IM1a may be moved from the region R3 to the region R1 across the region R2.

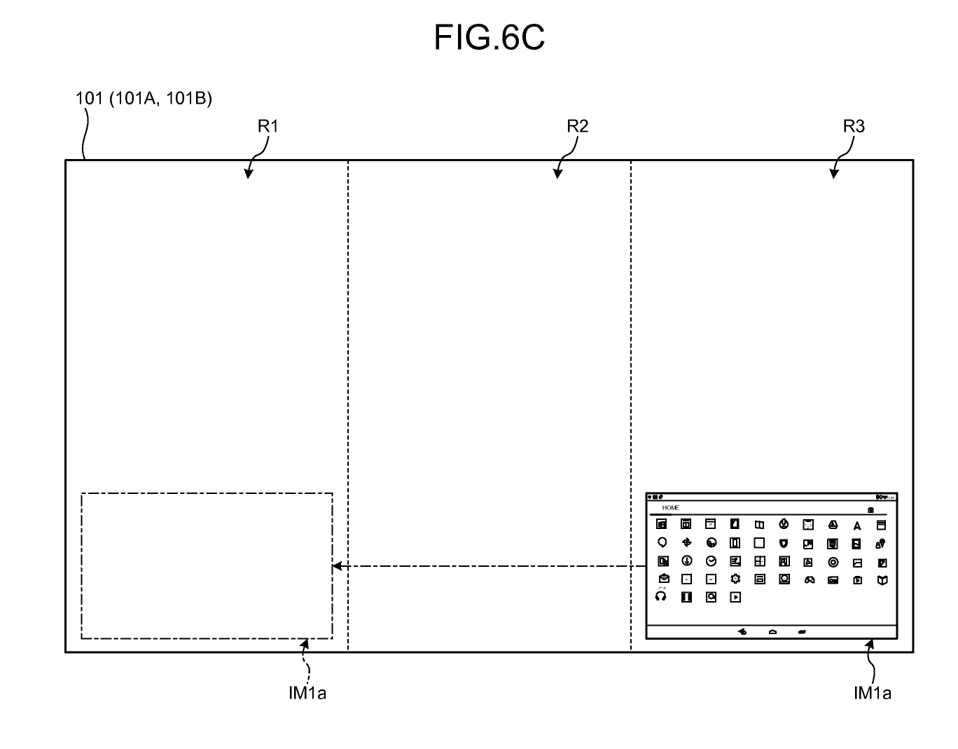

In the examples of FIGS. 5 and 6A to 6C, the home screen IM1a is displayed on the display 101A that is horizontally arranged. Alternatively, in the embodiment, a home screen IM2 may be displayed on the display 101A that is vertically arranged as illustrated in FIG. 7. Similarly to the horizontal home screen IM1 in FIG. 5, a plurality of icons 12 are displayed on the vertical home screen IM2 for starting a plurality of applications installed in the video device 100.

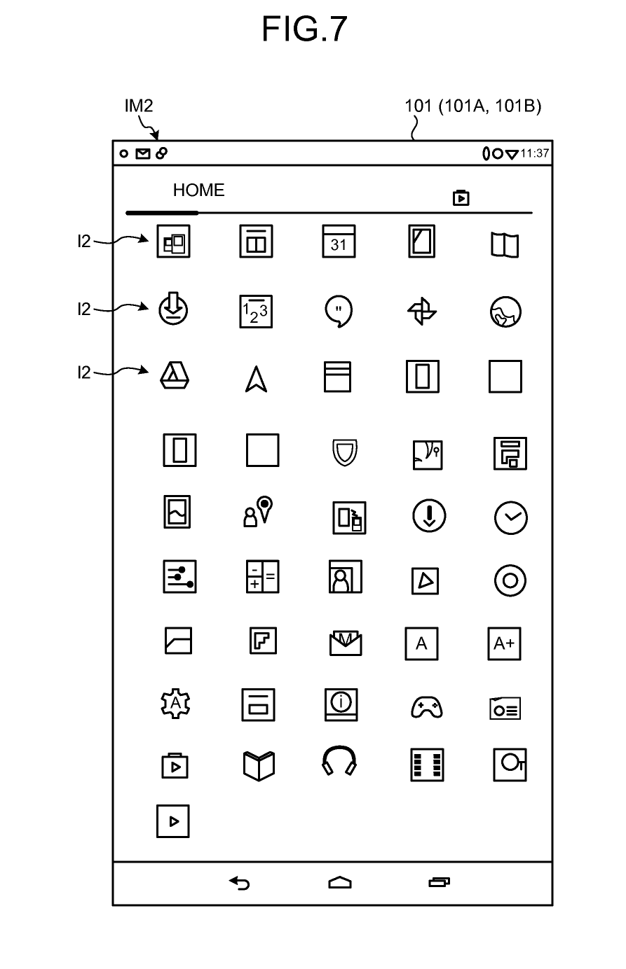

In the embodiment, similarly to the examples of FIGS. 5 and 6A to 6C, when the user approaches the display region of the display 101A, the vertical home screen IM2 in FIG. 7 is displayed in a reduced size on a region of a part of the display region, the region corresponding to the position of the user's face. That is, the display processor 303 is configured to display, when the user approaches the display region in a state where the home screen IM2 in FIG. 7 is displayed on the display 101A, a reduced-size home screen IM2a obtained by reducing in size the home screen IM2 on each of regions R11 to R13 that is a part of the display region corresponding to the position of the user's face as illustrated in FIGS. 8A to 8C. Similarly to the examples of FIGS. 6A to 6C, the display region may be divided into four or more regions, and a display position and a size of the reduced-size home screen IM2a can be adjusted in the examples of FIGS. 8A to 8C.

In the embodiment, the horizontal home screen IM1 (refer to FIG. 5) is reduced in size to be a horizontal reduced-size home screen IM1a (refer to FIGS. 6A to 6C), and the vertical home screen IM2 (refer to FIG. 7) is reduced in size to be a vertical reduced-size home screen IM2a (refer to FIGS. 8A to 8C). That is, in the embodiment, aspect ratios of the home screens IM1 and IM2 (refer to FIGS. 5 and 7) are the same as aspect ratios of the reduced-size home screens IM1a and IM2a (refer to FIGS. 6A to 6C and FIGS. 8A to 8C), respectively. Thus, when the display region of the display 101A is vertically long, the display processor 303 in the embodiment sets the first region for displaying the reduced-size operation image to be vertically long. In addition, when the display region of the display 101A is horizontally long, the display processor 303 sets the first region for displaying the reduced-size operation image to be horizontally long.

In the embodiment, display with reduction as described above is canceled when predetermined time has elapsed after a user's operation on the reduced-size operation image via the touch panel 101B is finished. That is, the display processor 303 in the embodiment is configured to hide the reduced-size operation image when predetermined time has elapsed after the user's operation on the reduced-size operation image via the touch panel 101B is finished, and to display an original operation image in the whole display region. In the embodiment, such a function of automatically performing the display with reduction can be switched on/off through the user's operation.

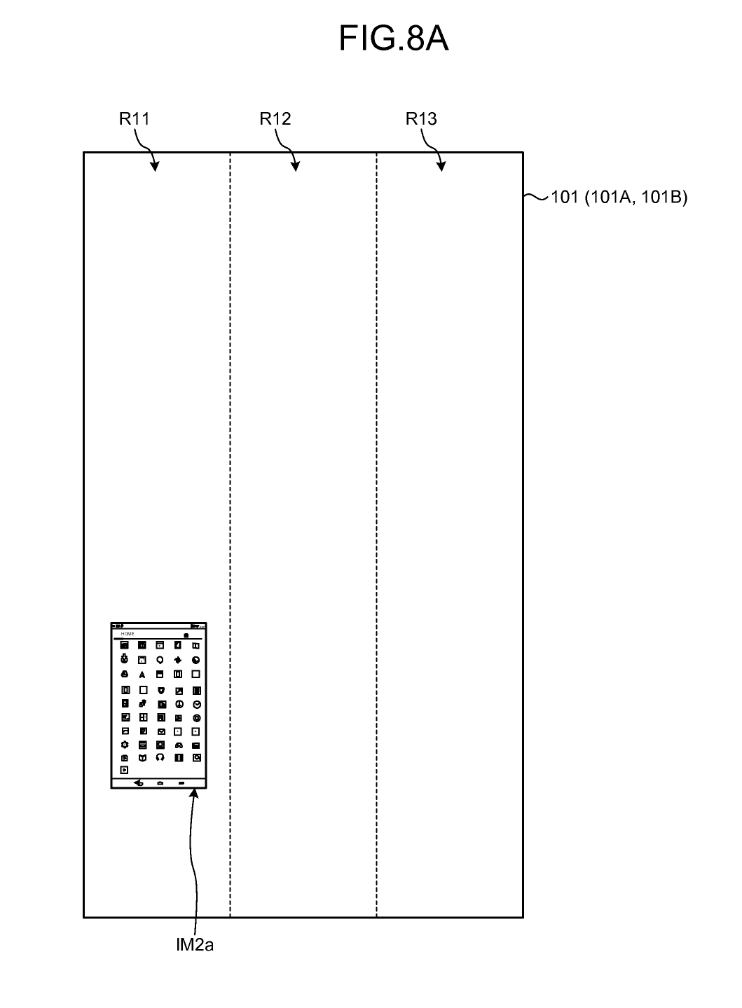

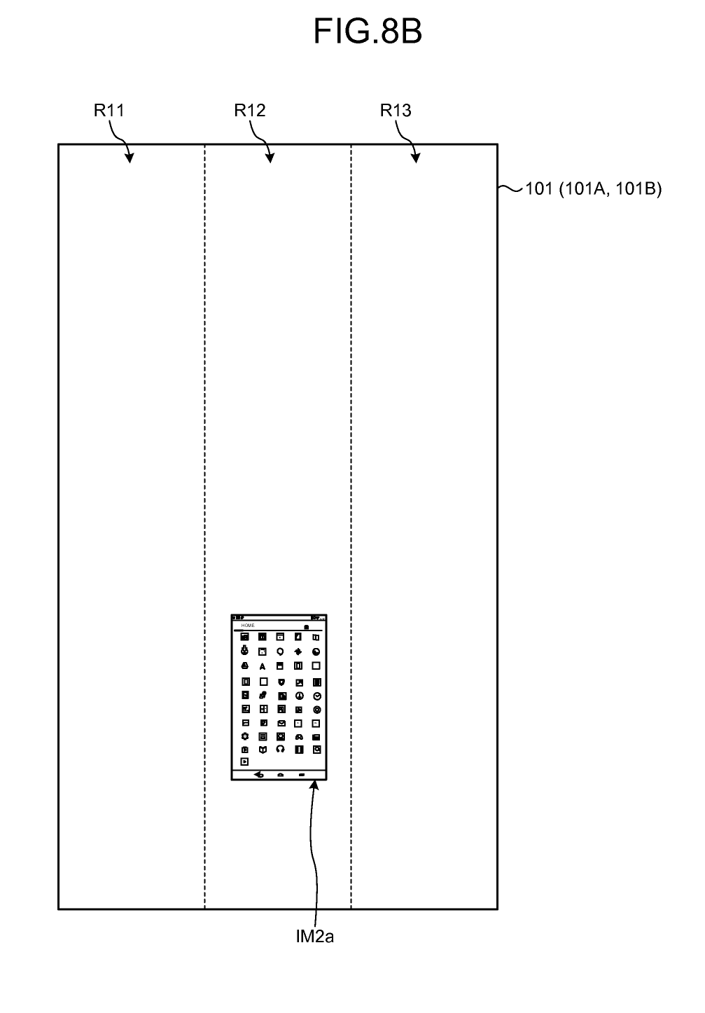

Another example of the operation image includes a keyboard screen, in the embodiment. The keyboard screen is a screen comprising a software keyboard for inputting characters as illustrated in FIGS. 9 and 10, for example. A keyboard screen IM3 in FIG. 9 is a horizontal screen comprising a software keyboard IM3a, and a keyboard screen IM4 in FIG. 10 is a vertical screen comprising a software keyboard IM4a. Similarly to the home screens IM1 and IM2, these keyboard screens IM3 and IM4 are displayed in a reduced size in the first region corresponding to the position of the user's face, which is a part of the display region, when the user approaches the display region.

Returning back to FIG. 3, the setting processor 304 is configured to manage settings of the default display position and size of the reduced-size operation image (refer to FIGS. 6A to 6C and FIGS. 8A to 8C). The input controller 305 is configured to detect the input operation by the user. The communication controller 306 is configured to control transmission/reception of the data to/from a portable terminal 400 described later via the communication module 103.

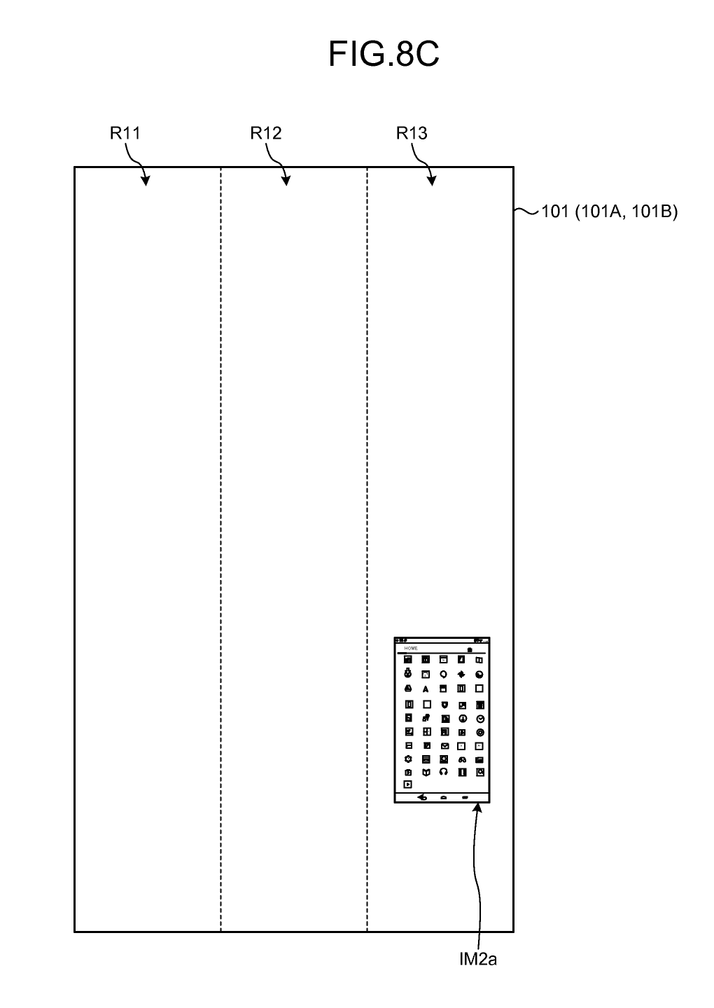

In the embodiment, a menu bar B1 as illustrated in FIG. 11 can be displayed by touching the touch panel 101B in a state where a video other than the operation image is displayed on the display 101A. The menu bar B1 in FIG. 11 comprises a home button B11 for switching display content of the display 101A to the home screen, a back button B12 for returning the display content of the display 101A to previous content, and a history button B13 for displaying a history of the display content of the display 101A displayed thereon. In the example of FIG. 11, the display 101A is horizontally arranged, thereby the horizontal home screen IM1 in FIG. 5 is displayed when the home button B11 is touched. The menu bar B1 can also be displayed in the home screen IM1 in FIG. 5, the home screen IM2 in FIG. 7, the reduced-size home screen IM1a in FIGS. 6A to 6C, the reduced-size home screen IM2a in FIGS. 8A to 8C, the keyboard screen IM3 in FIG. 9, and the keyboard screen IM4 in FIG. 10.

The display processor 303 in the embodiment is configured to display the home screen in a reduced size in a region comprising a region on which the home button B11 is displayed in the display region when the home button B11 of the menu bar B1 is touched. The fact that the home button B11 is touched indicates that the user is present at a position where the user can reach the home button B11. Accordingly, when the home screen is displayed in a reduced size on a region comprising a region on which the home button B11 is displayed, the reduced-size home screen is displayed at a position where the user can easily operate the home screen.

Here, to display the reduced-size operation image as described above, the user needs to approach the display 101A. In particular, when a video other than the operation image is displayed on the display 101A, the home screen cannot be called by touching the home button B11 unless the user approaches the display 101A to display the menu bar B1 (refer to FIG. 11).

Therefore, the communication controller 306 in the embodiment is configured to transmit image data corresponding to the operation image for operating the video device 100 to an external device when a distance between the user and the display 101A is larger than a threshold. The external device is configured to be able to display the operation image of the video device 100 on a display of the external device based on the received image data.

Specifically, the communication controller 306 is configured to transmit the image data corresponding to the operation image to the external device when the distance between the user and the display 101A is larger than the threshold and an image currently displayed on the display 101A is the operation image. With this configuration, the same effect as those obtained by operating the operation image of the video device 100 can be obtained by simply operating the image displayed on the external device, without approaching the video device 100 to display the reduced-size operation image.

The communication controller 306 is configured to transmit the image data corresponding to the home screen of the video device 100 to the external device, when the distance between the user and the display 101A is larger than the threshold and the image currently displayed on the display 101A is a video other than the operation image. With this configuration, the same effect can be obtained as those obtained by operating the home screen of the video device 100 while displaying the video other than the operation image on the video device 100, by simply operating the image displayed on the external device without approaching the video device 100 to call the home screen.

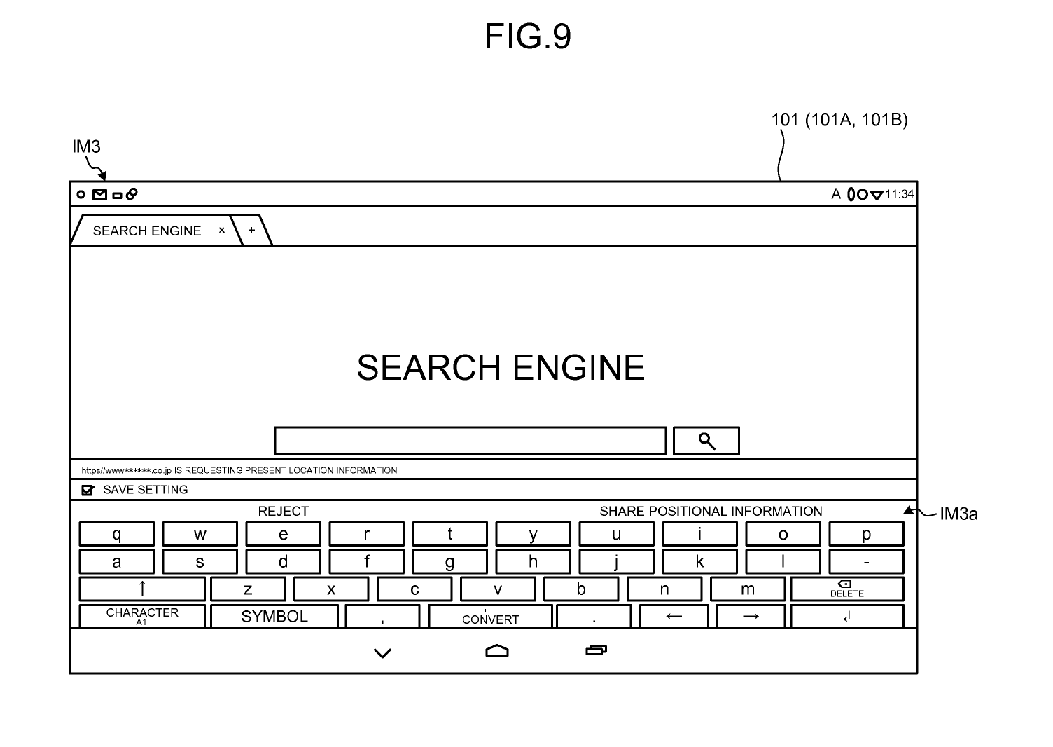

An example of the external device described above includes the portable terminal 400 illustrated in FIG. 12. The portable terminal 400 is a portable information processing device (information processor) such as a smartphone and a tablet computer. The portable terminal 400 comprises a display module 401 that can display a video. In the embodiment, a common electronic device other than the portable information processing device may be used as the external device.

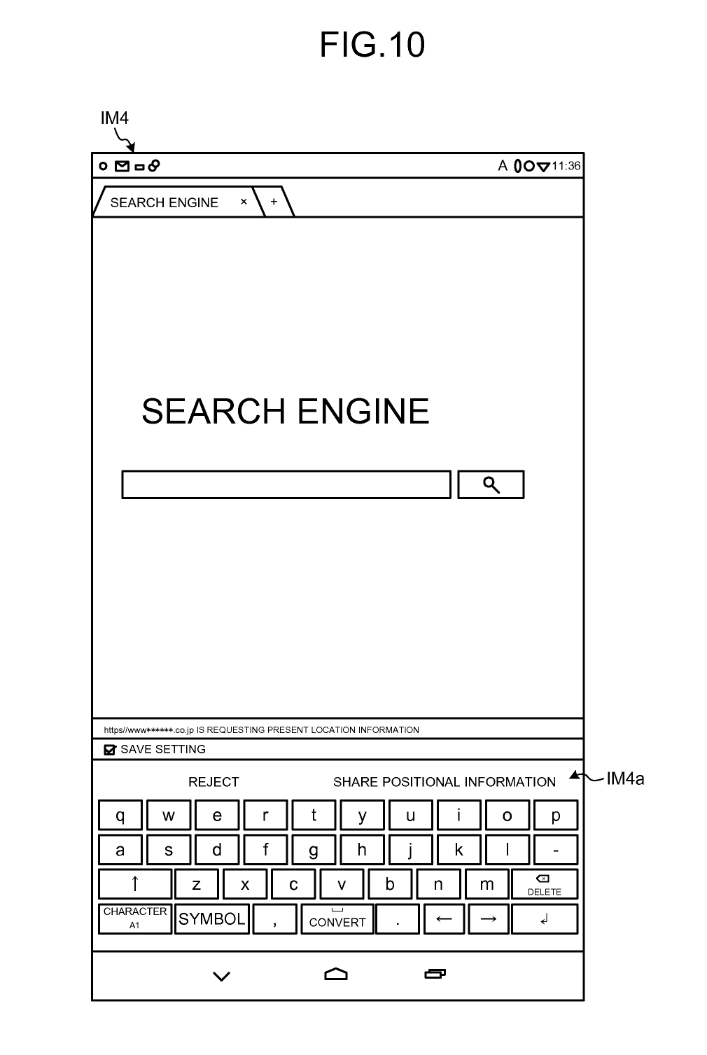

The following describes a hardware configuration of the portable terminal 400 in more detail with reference to FIG. 13.

As illustrated in FIG. 13, the portable terminal 400 mainly comprises a display module 401, a communication module 402, an operation module 403, a graphics controller 404, a touch panel controller 405, a CPU 406, a memory 407, and a storage 408.

The display module 401 is what is called a touch screen device combining a display 401A and a touch panel 401B. Examples of the display 401A include an LCD device or an organic EL display device. The touch panel 401B is configured to detect a touch position in a display region of the display 401A touched by a user's finger, a stylus, and the like.

The communication module 402 is an interface for transmitting/receiving data to/from other devices (such as the video device 100). The operation module 403 is a device such as a physical switch or button for operating the portable terminal 400 independent of the touch panel 401B. The graphics controller 404 is configured to control a video output to the display 401A. The touch panel controller 405 is configured to control the touch panel 401B to acquire coordinate data indicating the touch position in the display region touched by the user.

The CPU 406 is configured to execute various computer programs to control each component of the portable terminal 400. The memory 407 comprises, for example, a ROM and a RAM serving as main storage devices, and is configured to store various computer programs and various pieces of data used for various processing executed by the CPU 406. The storage 408 comprises, for example, an HDD and an SSD serving as auxiliary storage devices.

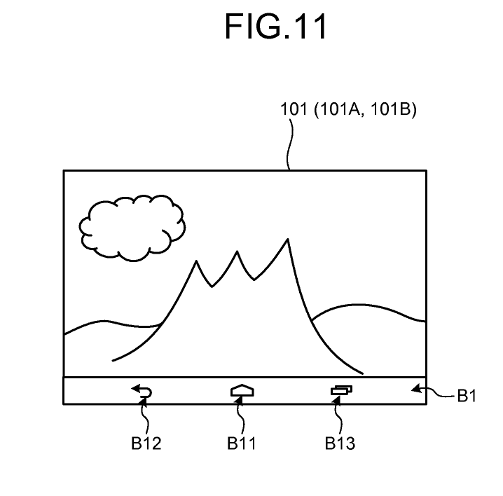

The CPU 406 is configured to execute a computer program 500 as illustrated in FIG. 14. The computer program 500 has a modular configuration as follows.

As illustrated in FIG. 14, the computer program 500 comprises a communication controller 501, a display processor 502, and an input controller 503. Each of these modules is generated on the RAM of the memory 407 when the CPU 406 reads and executes the computer program 500 from the ROM of the memory 407.

The communication controller 501 is configured to control transmission/reception of the data to/from the video device 100 via the communication module 402. For example, the communication controller 501 is configured to acquire, from the video device 100, the image data corresponding to the home screen of the video device 100.

The display processor 502 is configured to output a video to the display 401A. The display processor 502 is configured to display, when the communication controller 501 acquires the image data corresponding to the home screen of the video device 100, for example, a screen IM5 (refer to FIG. 12) for operating the video device 100 on the display 401A based on the acquired image data.

The input controller 503 is configured to detect the input operation by the user. For example, the input controller 503 is configured to notify the communication controller 501 of operation information about an operation of touching an icon on the screen IM5 in FIG. 12 when detecting the touching operation. In this case, the communication controller 501 is configured to transmit, to the video device 100, the operation information notified from the input controller 503. With this configuration, the same effect as those obtained by operating the operation image of the video device 100 can be obtained by simply operating the screen IM5 of the portable terminal 400 without approaching the video device 100.

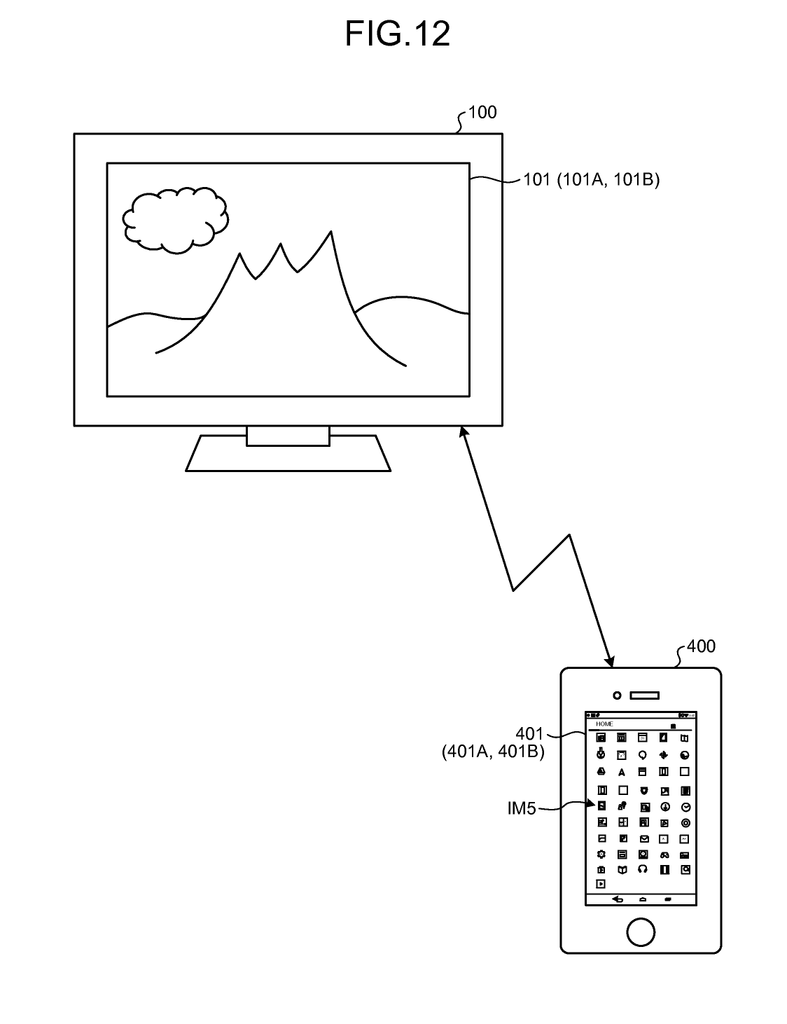

Next, with reference to FIG. 15, the following describes processing executed by the video device 100 to display the reduced-size operation image, in the embodiment. A processing flow in FIG. 15 is started when the computer program 300 in FIG. 3 is called through the user's operation and a function of automatically displaying the operation image in a reduced size is on.

In the processing flow in FIG. 15, at S1, the camera controller 301 acquires an image imaged by the camera 200.

At S2, the detection processor 302 detects the position of the user's face and the distance between the user and the display 101A based on the image acquired at S1.

At S3, the detection processor 302 determines whether the distance between the user and the display 101A is equal to or smaller than the threshold. When it is determined that the distance between the user and the display 101A is equal to or smaller than the threshold at S3, the processing proceeds to S4.

At S4, the display processor 303 determines whether an image currently displayed on the display 101A is the operation image. Examples of the operation image include the home screen IM1 in FIG. 5, the home screen IM2 in FIG. 7, the keyboard screen IM3 in FIG. 9, and the keyboard screen IM4 in FIG. 10.

At S4, when it is determined that the currently displayed image is the operation image, the processing proceeds to S5. Then at S5, the display processor 303 displays the reduced-size operation image on a region (first region) of apart of the display region, the first region corresponding to the position of the user's face. The processing is then ended. Meanwhile, when it is determined that the currently displayed image is not the operation image at S4, the processing is directly ended without performing display with reduction as in S5.

When it is determined that the distance between the user and the display 101A is larger than the threshold at S3, the processing proceeds to S6. At S6, the communication controller 306 determines whether the image currently displayed on the display 101A is the operation image.

When it is determined that the currently displayed image is the operation image at S6, the processing proceeds to S7. At S7, the communication controller 306 transmits, to the portable terminal 400, image data corresponding to the currently displayed operation image. The processing is then ended.

When it is determined that the currently displayed image is not the operation image at S6, the processing proceeds to S8. At S8, the communication controller 306 transmits, to the portable terminal 400, image data corresponding to the home screen of the video device 100 that is not currently displayed. The processing is then ended.

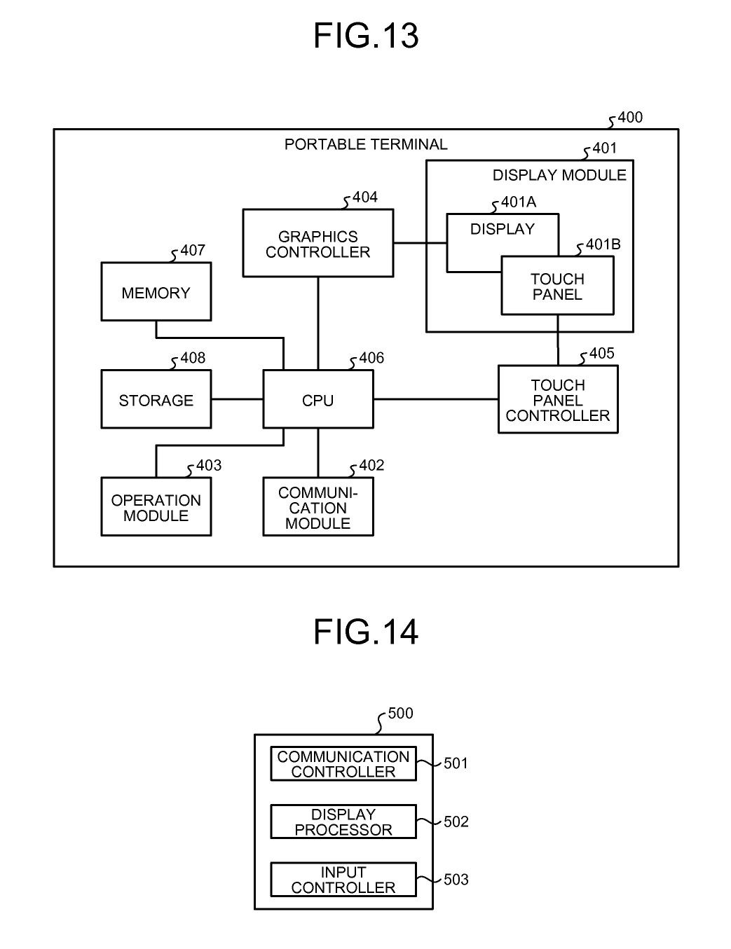

Next, with reference to FIG. 16, the following describes processing executed by the video device 100 to change the display position and the size of the reduced-size operation image, in the embodiment.

In a processing flow in FIG. 16, at S11, the display processor 303 determines whether the input controller 305 detects an operation of changing the display position and the size of the reduced-size operation image displayed on the display 101A. That is, the display processor 303 determines whether the input controller 305 detects an operation, such as a swipe (drag) operation, a flick operation, a pinch operation, and the like, on a region of a part of the touch panel 101B corresponding to the reduced-size operation image.

The processing at S11 will be repeated until it is determined that the operation of changing the display position and the size of the reduced-size operation image is detected. When it is determined that the operation of changing the display position and the size of the reduced-size operation image is detected at S11, the processing proceeds to S12.

At S12, the display processor 303 changes the display position and the size of the reduced-size operation image displayed on the display 101A in response to the operation detected at S11. The processing is then ended.

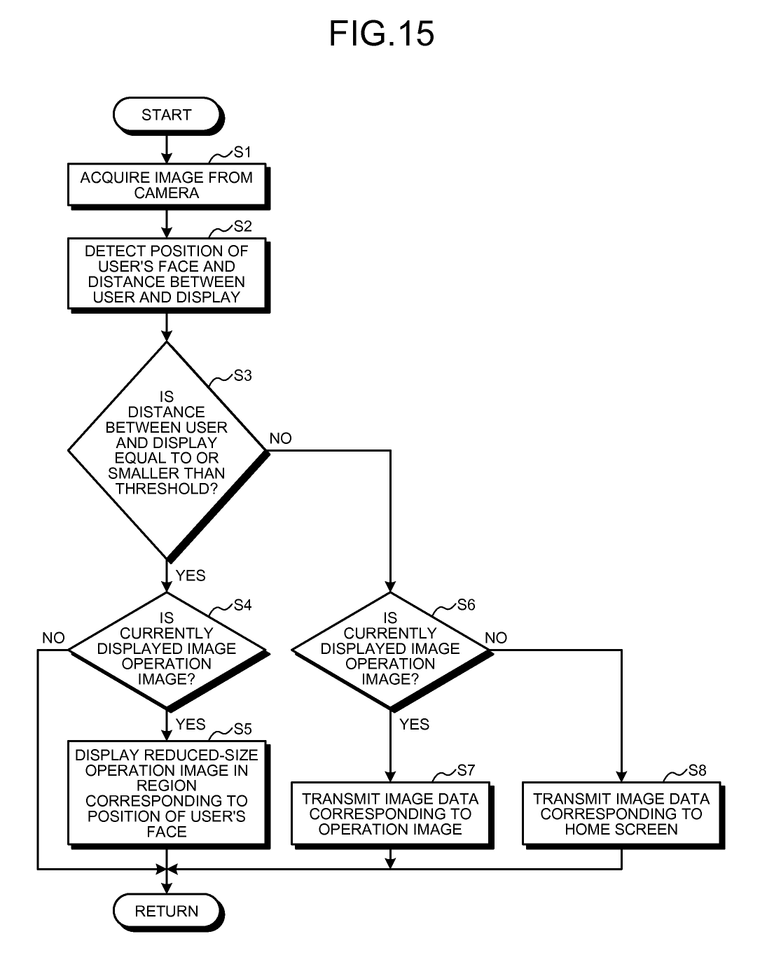

Next, with reference to FIG. 17, the following describes processing executed by the video device 100 to cancel the display of the reduced-size operation image, in the embodiment.

In a processing flow in FIG. 17, at S21, the display processor 303 determines whether a predetermined time has elapsed after the user's operation on the reduced-size operation image via the touch panel 101B is lastly detected.

The processing at S21 will be repeated until it is determined that the predetermined time has elapsed after the user's operation on the reduced-size operation image is lastly detected. When it is determined that the predetermined time has elapsed after the user's operation on the reduced-size operation image is lastly detected at S21, the processing proceeds to S22.

At S22, the display processor 303 hides the reduced-size operation image, and displays the original operation image on the whole display region of the display 101A. The processing is then ended.

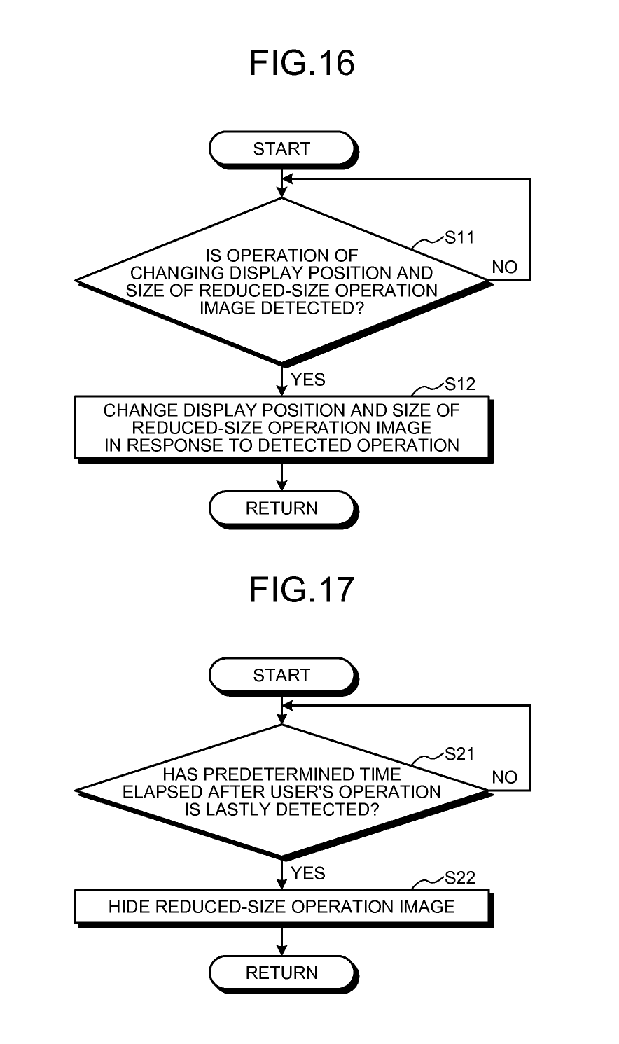

Next, with reference to FIG. 18, the following describes processing executed by the video device 100 to set the default display position and size of the reduced-size operation image, in the embodiment.

In a processing flow in FIG. 18, at S31, the setting processor 304 determines whether the input controller 305 detects an operation of setting the default display position and size of the reduced-size operation image.

The processing at S31 will be repeated until it is determined that the operation of setting the default display position and size of the reduced-size operation image is detected. When it is determined that the operation of setting the default display position and size of the reduced-size operation image is detected at S31, the processing proceeds to S32.

At S32, the setting processor 304 stores a setting corresponding to the operation detected at S31. The processing is then ended.

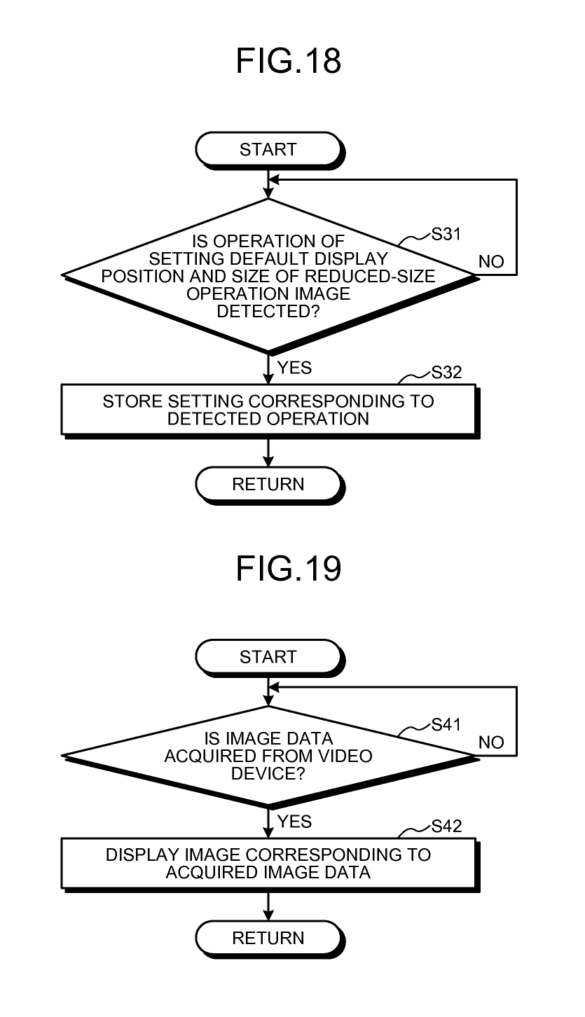

Next, with reference to FIG. 19, the following describes processing executed by the portable terminal 400 to display an image based on the image data received from the video device 100, in the embodiment. A processing flow in FIG. 19 is started when the computer program 500 in FIG. 14 is called through the user's operation.

In the processing flow in FIG. 19, at S41, the display processor 502 determines whether the image data is acquired from the video device 100. When the distance between the user and the display 101A of the video device 100 is larger than the threshold (No at S3 in FIG. 15), the image data is transmitted from the video device 100 to the portable terminal 400.

The processing at S41 will be repeated until it is determined that the image data is acquired from the video device 100. When it is determined that the image data is acquired from the video device 100 at S41, the processing proceeds to S42.

At S42, the display processor 502 displays an image corresponding to the image data acquired from the video device 100 on the display 401A of the portable terminal 400. The processing is then ended.

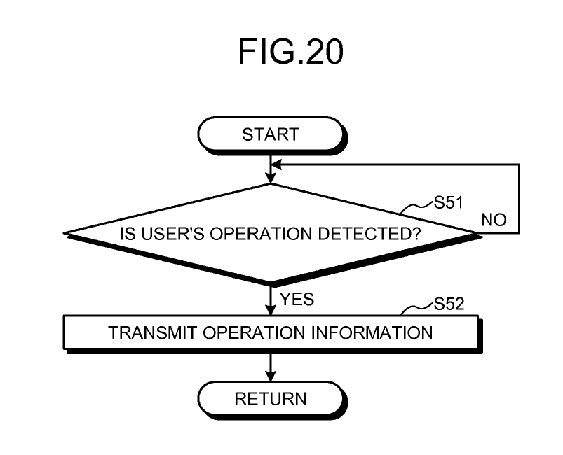

Next, with reference to FIG. 20, the following describes processing executed by the portable terminal 400 to transmit the operation information to the video device 100, in the embodiment.

In a processing flow in FIG. 20, at S51, the communication controller 501 determines whether the input controller 503 detects the user's operation on the image for operating the video device 100 displayed on the display 401A at S42 in FIG. 19.

The processing at S51 will be repeated until it is determined that the input controller 503 detects the user's operation on the image, which is displayed at S42 in FIG. 19, on the display 401A. When it is determined that the input controller 503 detects the user's operation on the image displayed on the display 401A at S51, the processing proceeds to S52.

At S52, the communication controller 501 transmits, to the video device 100, the operation information corresponding to the operation detected at S51. Accordingly, the user can remotely operate the video device 100 using the portable terminal 400 without approaching the display 101A of the video device 100. The processing is then ended.

As described above, the CPU 107 of the video device 100 in the embodiment executes the computer program 300 to configure the detection processor 302 and the display processor 303. The detection processor 302 is configured to detect the position of the user's face opposed to the display region of the display 101A. The display processor 303 is configured to display the reduced-size operation image on a region (first region) of a part of the display region based on the detection result of the detection processor 302 when the operation image is displayed in the display region. The reduced-size operation image is obtained by reducing in size the operation image. The first region corresponds to the position of the user's face. Accordingly, the operation image for operating the video device 100 is displayed at the position near the user in a reduced size that can be easily operated by the user. Therefore, in the embodiment, a burden on the user can be reduced in operating the video device 100 that is a large video display device having a touch panel function.

The computer program 300 (500) in the embodiment is provided as an installable or executable computer program product. That is, the computer program 300 (500) is provided while being included in a computer program product having a non-transitory computer readable medium such as a compact disc read only memory (CD-ROM), a flexible disk (FD), a compact disc recordable (CD-R), and a digital versatile disc (DVD).

The computer program 300 (500) above may be stored in a computer connected to a network such as the Internet, and may be provided or distributed via the network. The computer program 300 (500) may be embedded and provided in a ROM, for example.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video device capable of displaying a video on a display region of a display provided with a touch panel, the video device comprising:
an acquisition module configured to acquire an image from a camera configured to image a region opposed to the display region;
a detection processor configured to detect a position of a user's face opposed to the display region based on the acquired image; and
a display processor configured to display, based on a detection result of the detection processor when a first operation image to operate the video device is displayed on the display region, a second operation image obtained by reducing in size the first operation image on a first region of a part of the display region, the first region corresponding to the position of the user's face.

2. The video device of claim 1, wherein the display processor is configured to display the second operation image on the first region when it is confirmed that a distance between the user and the display is equal to or smaller than a threshold based on the acquired image.

3. The video device of claim 1, wherein the display processor is configured to hide the second operation image and display the first operation image on the display region when a predetermined time has elapsed after a user's operation on the second operation image via the touch panel is finished.

4. The video device of claim 1, wherein the display processor is configured to change a display position and a size of the second operation image in response to the user's operation on the second operation image via the touch panel.

5. The video device of claim 1, wherein the display processor is configured to set the first region to be vertically long when the display region is vertically long, and to set the first region to be horizontally long when the display region is horizontally long.

6. A method executed in a video device capable of displaying a video on a display region of a display provided with a touch panel, the method comprising:
acquiring an image from a camera configured to image a region opposed to the display region;
detecting a position of a user's face opposed to the display region based on the acquired image; and
displaying, based on a result of the detecting when a first operation image to operate the video device is displayed on the display region, a second operation image obtained by reducing in size the first operation image on a first region of a part of the display region, the first region corresponding to the position of the user's face.

7. The method of claim 6, wherein the displaying comprises displaying the second operation image on the first region when it is confirmed that a distance between the user and the display is equal to or smaller than a threshold based on the acquired image.

8. The method of claim 6, further comprising:
hiding the second operation image and displaying the first operation image on the display region when a predetermined time has elapsed after a user's operation on the second operation image via the touch panel is finished.

9. The method of claim 6, further comprising:
changing a display position and a size of the second operation image in response to the user's operation on the second operation image via the touch panel.

10. The method of claim 6, further comprising:
setting the first region to be vertically long when the display region is vertically long; and
setting the first region to be horizontally long when the display region is horizontally long.

11. A computer program product having a non-transitory computer readable medium including programmed instructions, wherein the instructions, when executed by a computer of a video device capable of displaying a video on a display region of a display provided with a touch panel, cause the computer to perform:
acquiring an image from a camera configured to image a region opposed to the display region;
detecting a position of a user's face opposed to the display region based on the acquired image; and
displaying, based on a result of the detecting when a first operation image to operate the video device is displayed on the display region, a second operation image obtained by reducing in size the first operation image on a first region of a part of the display region, the first region corresponding to the position of the user's face.

12. The computer program product of claim 11, wherein the displaying comprises displaying the second operation image on the first region when it is confirmed that a distance between the user and the display is equal to or smaller than a threshold based on the acquired image.

13. The computer program product of claim 11, wherein the instructions cause the computer to further perform:
hiding the second operation image and displaying the first operation image on the display region when a predetermined time has elapsed after a user's operation on the second operation image via the touch panel is finished.

14. The computer program product of claim 11, wherein the instructions cause the computer to further perform:
changing a display position and a size of the second operation image in response to the user's operation on the second operation image via the touch panel.

15. The computer program product of claim 11, wherein the instructions cause the computer to further perform:
setting the first region to be vertically long when the display region is vertically long; and
setting the first region to be horizontally long when the display region is horizontally long.
